(19) United States
(12) Patent Application Publication
(10) Pub. No.: US 2013/0012851 A1
(43) Pub. Date: Jan. 10, 2013

(54) VERSATILE MASSAGE THERAPY POLE

(76) Inventor: John Fahmie, Miami Beach, FL (US)

(21) Appl. No.: 13/526,504

(22) Filed: Jun. 18, 2012

Related U.S. Application Data
(60) Provisional application No. 61/498,534, filed on Jun. 18, 2011.

(51) Int. Cl. A61H 15/00

(52) U.S. Cl. 601/119

(57) ABSTRACT

The present invention discloses a portable versatile massage pole apparatus and methods for using same which enable the self-application of massage therapy and muscle manipulation to any part of a user's body. More particularly, the present invention describes a whole-body massage tool having a massage head variably comprising rollers, acupressure knobs, electrical stimulators and other massage tools and which is rigidly attached to an elongate, semiflexble pole between three and twelve feet long. The pole is anchored at one end such that the apparatus functions as a class 3 lever, enhancing the power and control of massage strokes administered via the massage head on the opposing end. An optional cross-bar or handles may be attached to the pole for increased control. The anchoring means can be attached to stationary surfaces and brackets or to adjustable devices such as a smith machine.

### CROSS REFERENCE TO RELATED APPLICATIONS

This application claims the benefit of U.S. Provisional Application No. 61/498,534 filed Jun. 18, 2011.

### BACKGROUND OF THE INVENTION

1. Field of the invention

The present invention relates to portable handheld massage devices. More particularly, the present invention describes a whole-body massage tool having a multifunctional massage head directly attached to an elongate pole that enables the self-application of massage therapy and muscle manipulation to any part of the body and that applies leverage for substantially increasing, relative to devices in the prior art, the force and control of massage strokes achievable during self-application of massage therapy.

2. Description of the related art

The following review of related art is intended to provide edifying examples of problems and pitfalls in the design and use of portable hand-held self-massage devices. The mention of these examples does not constitute an admission that any of the following devices constitute prior art applicable to the device of the present invention.

Portable handheld massage devices attempt to substitute for the services of a masseuse by permitting a user to self-apply massage therapy. Massage therapy is intended to provide relief to sore, injured, inflamed, or stressed tissues of the body as well as to provide general relaxation and pleasure. Prior art portable handheld massage devices fall short of these goals for numerous reasons, principally: (1) prior art devices do not enable a user to comfortably apply massage therapy to all regions of the body, particularly the lower and center back; (2) prior art devices do not enable a user to provide maximum force, e.g., force sufficient to perform certain massage therapies such as deep tissue massage or active relief therapy, to affected areas of the body without excessively exerting the user's muscles; and (3) Prior art devices require the user to contort the arms and shoulders in order to reach certain areas of the body during self-massage, or to otherwise assume uncomfortable positions, which in turn reduces or eliminates the benefits of massage.

The group of inventions described in: U.S. Pat. App. Pub. No. 20100094333 to Akcasu, U.S. Pat. App. Pub. No. 20050202944 to Deal, U.S. Pat. No. 4,493,315 to Iwahashi, U.S. Pat. No. 5,730,708 to Spratt, U.S. Pat. No. 5,364,338 to Terashima, U.S. Pat. No. 6,241,693 to Lambden, and U.S. Pat. No. 6,988,997 to Stultz present devices which comprise freely moving spheroidal body-contacting elements, i.e., massage heads, attached to one or two short handles via elastic or flexible connecting means. These elastic or flexible connecting means variously comprise springs, elastic bands, tubes, joints, hinges, or the like. The elasticity or flexibility intervening between the handle and the massage head produces a distinct drawback: the elastic or flexible connecting means preclude transfer of mechanical force through the handle and onwards through the body-contacting elements of the massage head when placed against the user's body, because force applied to the handle is dissipated by the elasticity or flexibility at the connector means. In order to apply maximum pressure against parts of the body using these types of handheld massage devices, the user must either (1) squeeze the massage head against a hard surface such as a wall, floor, or other stationary surface (see U.S. Pat. App. Pub. No. 20100094333 to Akcasu) or (2) pull the hand held massage device against the body like a cradle or lasso (see U.S. Pat. No. 4,493,315).

Another problem with these devices is that in order to pull them against the body using maximum force, the user must rigorously use his or her own muscles. This defeats the purpose of self-massage because the muscles of the body should remain relaxed during a massage, and many types of therapies are impossible or ineffective when applied to the body while muscles are actively flexing or are being maintained in a tense state.

This muscle tension problem is also inherent in devices that, although they may not contain any elastic connector means, nevertheless require the user to pull the device against his or her own body using substantial muscular force. For example, the devices described in U.S. Pat. App. Pub. No. 20050113726 to Prettyman, U.S. Pat. App. Pub. No. 20040249325 to Stultz, and U.S. Pat. No. 5,560,746 to Willow depend directly upon the user's strength to apply pressure to body tissues with the attached massage element. In order to achieve maximum pressure, the user must pull the device directly against himself as hard as he or she can.

Many handheld self massage devices include a curved or J-shaped handle. Unfortunately, the J-shape is especially prone to buckling or warping when pressure is placed upon it, requiring heavy-duty construction which increases the weight and cost of the device. J-shaped devices are typically not equipped with a single, semi-flexible pole or handle, but instead contain handles comprising multiple pieces, or handles composed of an absolutely rigid material. It would be more favorable to have a single, semi-flexible handle because this would enhance the user's ability to palpitate—to sense contours, muscle tone, and the like—by detecting the transference of vibrations and sensory information directly from the massage head element through the handle and to the hands of the user. Palpitation is impaired by handles comprising multiple elements, jointed elements, j-shaped elements, or absolutely rigid materials.

Another distinct category of portable hand-held self-massage devices include the short-handled massagers described in U.S. Pat. No. 7,137,960 to Tien, U.S. Pat. No. D371,607 to Taylor, U.S. Pat. No. D274,555 to Shiu, U.S. Pat. No. D270,279 to Hamilton, U.S. Pat. No. D259,142 to Lee, et al., U.S. Pat. No. 3,850,163 to Andis, U.S. Pat. No. 2,621,652 to Erhardt, and U.S. Pat. No. 1,908,051 to Reichl. These inventions are primarily suited for application by a second person to the body of a first person, but they also provide a rudimentary capability to facilitate self-massage. With respect to self-massage, the principal benefit granted by these devices is that they slightly increase the reach of a user's arms. They typically employ spheroidal, rolling body-contacting elements at the termini of their respective handles. Such devices require the user to orient the arms and rotate the shoulders into uncomfortable positions in order to reach certain parts of the body, such as the center back. Much like a common back-scratcher, they simply allow users to reach farther behind their own backs than would otherwise be possible without the massager.

Massage devices with short, rigid handles cannot be used as efficient lever/fulcrum mechanisms to amplify pressure applied during self-massage. The user must push these devices awkwardly against the body in order to apply pressure to tissues other than those of the arms and legs. For example, reaching behind one's back with this type of massager, a user must flex the biceps or deltoids in order to push the rollers into the muscles of the back. When the arm is bent or the shoulder is rotated anteriorly, the biceps and deltoids are at a mechanical disadvantage, respectively. This exacerbates the discomfort and awkwardness inherent in the design and use of these devices. It also reduces the ability of the user to fine tune the amount and direction of force, and to dexterously apply it, during self-applied massage therapy. Certain classes of individuals with limited mobility in their arms or shoulders, or limited strength, cannot benefit from such devices at all.

In general, the body cannot achieve a sufficiently relaxed state during a whole-body self-massage using these devices. As another example, when a user massages his or her pectoral (chest) muscles with a short-handled self massage device, he or she must use force generated substantially by the pectoral muscles to press the device into the chest, making it impossible to both massage and relax the pectoral muscles at the same time.

Long handled pole-type massage devices are represented by U.S. Pat. App. Pub. No. U.S. 20060185615 to Gorin. This device features an elongated control handle, a nodulated massage head attachment, and a cylindrical cone-shaped bristled tool-head attachment. This device is not amenable to self-application and is designed primarily for the grooming of horses. The elongated linear massage head comprises a series of bulbous nodules. The groomer uses the device by standing several feet away from a horse and rubbing the tool-head attachment along the horse's skin at strategic locations on the horse's body. The bulbous nodules are rubbed back and forth over the skin to provide an “auto-mechanical vibration” when the nodules lightly bounce on-and-off the body surface. This motion is intended to create a soothing sensation that mimics the touch of a mother mare licking and nudging her newborn foal, and it is not appropriate for deep tissue or other more rigorous massage therapy techniques.

U.S. Pat. No. 6,764,454 to Tu describes a “fitness stick” having a sheath with many small protuberances and a moxibustion flapping bat. It provides self massage by being rolled transversely over an area of the body and cannot reach the back of the body. Massagers which are rolled transversely across areas of the body should not be compared to the device of the present invention, which uses a distinctive method of application.

In light of the above, there is a need for a versatile handheld self-massage device that can generate both very large and minute amounts of force directed against any point on the body while requiring the minimum amount of muscle flexion by the user, while permitting the arms and shoulders to remain in comfortable positions at all times, while providing superior control over the amount and direction of force applied to precise target locations anywhere on the body, while providing leverage greatly exceeding that which users could achieve by their muscle power alone, by omitting flexible connecting elements that interrupt the transference of energy from the handle to the body-contacting element, by omitting joints and curves in the handle which preclude the transference of sensory information from the body contacting element to the user's hands (and which therefore impede palpitation), by omitting the need to “sandwich” the body-contacting element between a wall or floor surface and the user's body, by having sufficient length to comfortably reach any part of the body (particularly the center back), by creating an efficient lever/fulcrum function to produce an amplified transfer of massage pressure to a target site on the body, and by comprising inexpensive, durable, weather-resistant materials for use in any location either indoors or outdoors.

No admission is made that any reference, including any patent or patent document, cited in this specification constitutes prior art. It will be understood that, unless otherwise stated, reference to any document herein does not constitute an admission that any of these documents forms part of the common general knowledge in the art in United States of America or in any other country. The discussion of the references state merely what the author asserts, and the applicant reserves the right to challenge the accuracy and pertinency of any of the documents cited herein.

### SUMMARY OF THE INVENTION

The present invention satisfies the above needs and provides additional novel and nonobvious improvements over the prior art. The present invention resides not merely in any one of the features set forth in this specification, but also in the particular combination of all of the features and improvements claimed. The devices and methods of the present invention may be marketed as “Bodipole,” “Powerpole,” “BodyBar,” “BodyPowerBar,” and other related tradenames. The basic structure of the preferred embodiment of the present invention is as follows:

(1) An elongate pole (between 3 and 12 feet long) made of wood, plastic, or other rugged material. The pole is sturdy and resilient, designed to flex slightly when force is applied transversely to it but to simultaneously withstand strong force without buckling or cracking. And,

(2) An anchoring means at the distal end of said pole which serves mounting and/or stabilizing functions, allowing the distal end of the pole to remain fixed in a desired location, thereby creating the fulcrum of a class three lever. In this lever abstraction, the pole is the beam. The load is the massage pressure being applied at the proximal end where the massage head is rigidly attached. The force is provided by the user through his or her bodyweight or through direct or indirect manipulation of the pole.

The anchoring means may be fixed in a variety of configurations, such as to position the distal end of the device on a floor other stationary horizontal surface, in a corner between two walls or similar apposing vertical surfaces, in soil, in sand, or in other outdoor media. The anchoring means may act alone or in conjunction with a counterpart on an external surface such as a mounting bracket on a wall or in a doorframe, or on the sliding collar of a smith machine. During use of the invention, the anchoring means may be located in a position that is underfoot, overhead, or lateral to the user's body. The anchoring means and/or distal end of the pole may remain stationary throughout an entire massage session or it may be moved during the session to adjust and control the leverage achieved by the device of the present invention. And,

(3) A proximal end rigidly connected to a massage head element. In some embodiments, a massage head may be directly attached to the proximal end of the pole. In other embodiments, the massage heads may be attached to a mounting piece or carriage which itself is rigidly mounted to the proximal end of the pole. The latter configuration permits the massage head to contain rollers or wheels in certain embodiments, and other various massage head attachments.

(4) A massage head element which may be used to perform acupressure, palpitation, rolling massage, transcutaneous electronic nerve stimulation, and any other massage therapies when placed against body tissues. This massage head may be made of any suitable material including wood, plastics, rubber, and lightweight metals. The prongs, rollers, bulbs and other components of the massage head may be stationary, flexible, or rotatable. They may be permanently mounted to the proximal end of the pole or they may be removable and interchangeable, so long as they are rigidly attached and not flexibly attached to the pole. In at least one embodiment, a rigidly attached massage head comprises two wheels and their corresponding carriage from a landsurf board, a component adopted from the sport of land surfing, which is similar to skateboarding.

The direction and intensity of the force applied to the body through the massage head are controlled by the user in at least three ways. First, they are controlled through his or her manipulation of the pole element. Second, they are controlled through the lever effect achieved by the device when the anchoring means is attached to an external object or surface. Third, they are controlled by the user making slight adjustments to the position of the body when it is being contacted by the massage head. An optional cross bar or handle grip may be attached to the pole to provide enhanced control.

The forgoing summary has outlined some features consistent with the present invention in order that the following detailed description thereof may be better understood, and in order that the present contribution to the art may be better appreciated. The present invention is not limited in its application, details, or components merely to those set forth in the following description and illustrations. Devices consistent with the present invention are capable of other embodiments. Also, the phraseology and terminology employed herein are for the purpose of description and should not be regarded as limiting unless explicitly stated as such.

Those skilled in the art will appreciate that the conception upon which this disclosure is based may readily be utilized as a basis for designing of other structures, methods, and systems for carrying out the several purposes of the present invention. It is important, therefore, that the claims be regarded as including such equivalent constructions insofar as they do not depart from the spirit and scope of the devices consistent with the present invention.

### BRIEF DESCRIPTION OF THE DRAWINGS

FIG. 1A is a perspective view of the versatile massage therapy pole of the present invention.

FIG. 1B is a perspective view of an alternative embodiment of the versatile massage therapy pole of the present invention comprising a distinct massage head.

FIG. 2 is a side view of a user performing a lower back massage, demonstrating the method of leaning into the device to generate force, and pointing out the particular benefits of not having a connector means between proximal end of the pole and the massage head.

FIG. 3 is a side view of a person using the device to apply massage to the trapezius muscle while the anchoring means is pressed against a wall, demonstrating the method of using the pole as a class three lever to amplify massage pressure in the massage head.

FIG. 4 is a perspective view of an alternative embodiment of the versatile massage therapy pole of the present invention comprising massage head with adjustable rolling wheels and studs, as well as having a length-adjustable pole.

FIG. 5 is perspective view of an alternative embodiment of the present invention comprising a massage head having an L-shaped base portion.

FIG. 6 is a side view of the handheld versatile personal massage device of the present invention in which the anchoring means comprises the sliding collar of a smith machine.

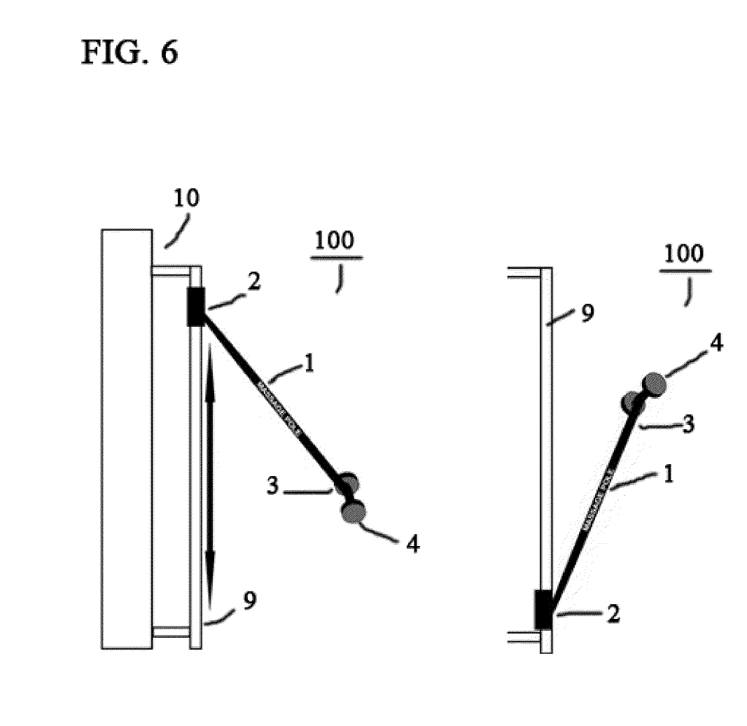

FIG. 7 is a front view of the present invention further comprising a cross bar attached to the pole to provide enhanced manual control of the massage experience.

### DETAILED DESCRIPTION OF THE DRAWINGS

Throughout all the Figures, same or corresponding elements are indicated by the same reference numerals.

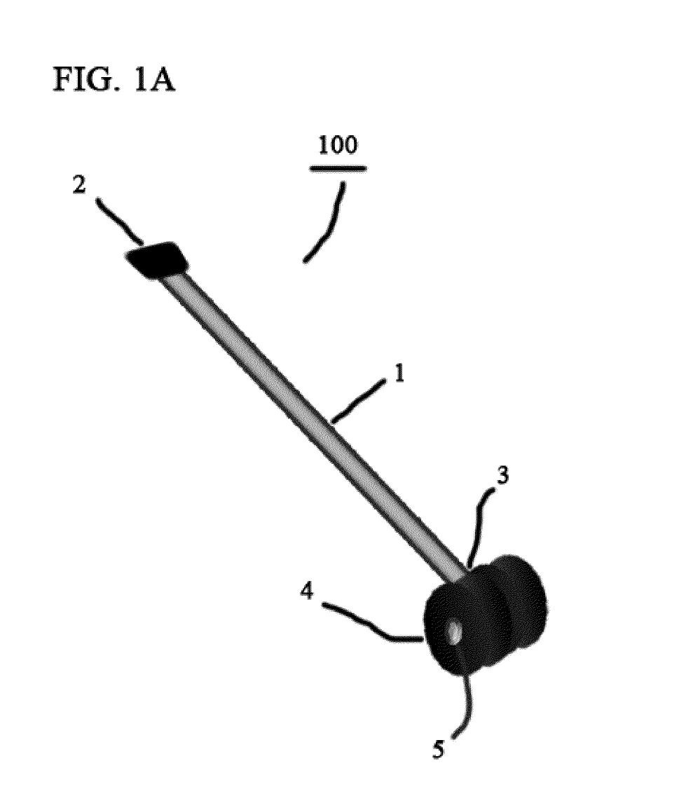

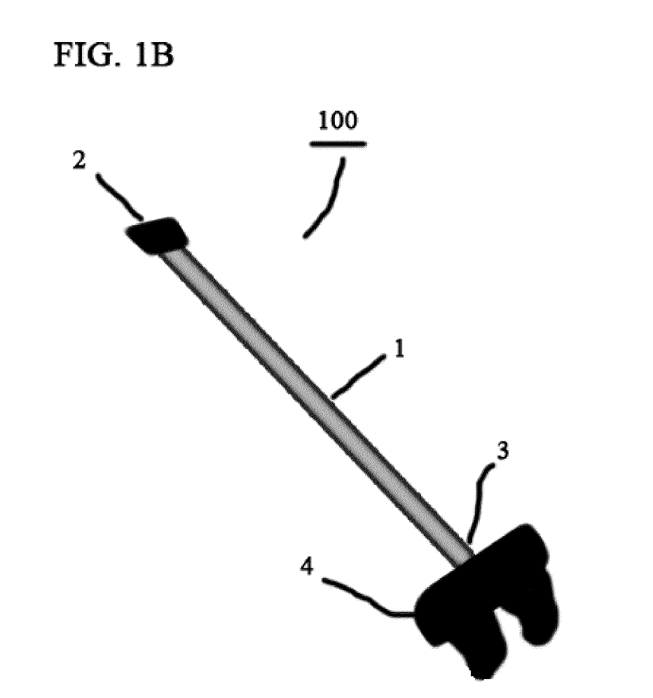

FIG. 1A shows the basic structure of the versatile massage therapy pole 100 of the present invention. An elongate pole 1 (between 3 and 12 feet long) is made of a light weight but strong material such as wood, graphite, or aluminum. In this embodiment, the pole 1 is made of wood and is designed to flex slightly when force is applied transversely to it and can withstand the force of approximately 100 pounds of pressure applied at its center. An anchoring means 2 is attached at the distal end of said pole. In this embodiment, the anchoring means 2 is a rubber end-cap that prevents the distal end of the pole from sliding on a surface. Force is provided by the user through his or her bodyweight or through direct manipulation of the pole 1. The massage pressure is transferred to the user's body at the proximal end 3 of the pole 1 through the rigidly attached massage head 4. Simultaneously, the user can palpitate his or her muscles using the massage head 4 which transfers tactile information to the pole 1 where it can be detected by the user's finger's or hands. In this way, the user may and detect differences in muscle tightness by sensing slight changes in the resistance of the pole to the force being applied to it or by sensing variations in the resistance of body tissues to pressure applied thereupon by the massage head 4 when the user manipulates the pole 1.

The massage head 4 in the embodiment of FIG. 1 is a pair of carbon rubber disks rigidly attached to the distal end 3 of the pole 1. A screw 5 may connect the disks of the massage head 4 directly to the proximal end 3 of the pole 1, or the screw 5 may connect the various parts of a massage head 4 to a carriage means or other joining means that is attached to the distal end 3 of the pole 1. The screw 5 is not necessary in all embodiments of the invention, and it may be substituted by other fasting means. The disks of the massage head 4 in this example each measure approximately three to eight inches in diameter and may be between 0.5 and 8 inches wide.

FIG. 1B is a perspective view of the massage pole 100 having a two-pronged massage head 4. The ability to have various massage heads in various configurations, including wheels that rotate on an axis, makes the massage pole of the present invention particularly versatile since the appropriate massage head can be used for any distinct type of massage therapy and distinct types of massage strokes can be best performed using distinct massage heads. The direction and intensity of the force applied to the body by the massage head 4 is controlled by the user when the user manipulates the pole 1 while the anchoring means 2 is positioned in its configuration as the fulcrum of a lever.

There are at least two ways to apply force to the body using the device of the present invention. One involves pushing the device against body tissues, and the other involves pulling the device against body tissues. In both methods, the distal end of the device must be planted or fixed to a stable surface or anchor point. The proximal end of the device and the rigidly attached massage head are directed to a target site on the user's body. The pole acts as a lever amplifying force up through the pole to the massage head.

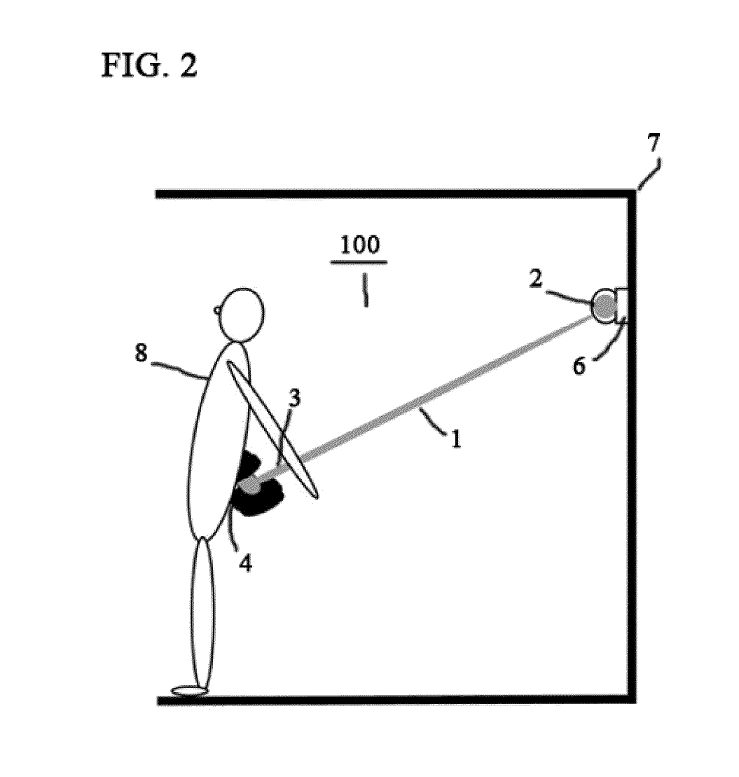

FIG. 2. Shows a preferred embodiment of the present invention 100 in which the user 8 pushes the muscles of the lower back against the massage head 4 by leaning into the proximal end 3 of the pole 1 and thereby pushing the muscles into the massage head 4. Resistance to this pushing is provided by the wall 7 supporting a bracket 6 attached to the anchoring means 2. Instead of the force of the massage being generated by the user's muscle power, gravity acting upon a user's body mass generates a large proportion of the force as the user leans into the massage head 4. The massage head 4 can be pushed directly into a portion of the body, such as a muscle or limb, or it can be rolled upwards and downwards along the length of the portion of the body. This rolling stroke is achieved most effectively using a massage head 4 having rolling wheels, but a similar stroke motion may be achieved using a stationary pronged massage head and may also be facilitated by the use of lubricants on the skin such as massage oil. The massage head 4 can be held against the body with steady or gradually building pressure, or it can be tapped or punched into the muscles. In any case, the user may move his or her body in concert with the device, or may otherwise adjust positioning, to achieve a range of interactions with the massage head 4, enabling the gamut of massage therapies, such as the examples explained below beginning at paragraph 0047.

In some prior art devices, a flexible connector element intervenes between the massage head and the handle of the device. FIG. 2 particular illustrates how the absence of flexible connector between the massage head 4 and pole 1 permits the user 8 to reap the maximum amount of pressure from the device when he or she leans into it. If the massage head 4 were flexibly attached to the present massage pole, it would twist and give way behind the user's back and thus make it difficult to control the force and direction of massage strokes. When the massage head 4 is rigidly attached to the proximal end 3 of the pole 1, force or pressure or resistance travels from the anchor means 2 all the way to the user's body unimpeded.

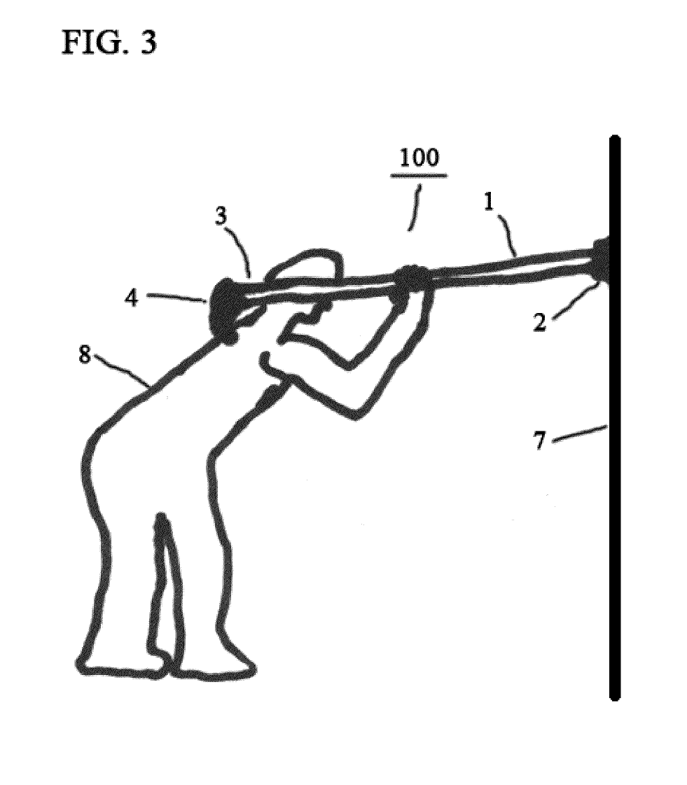

In another preferred embodiment, the user pulls on the pole transversely to its axis so that the massage head is pressed into a portion of the body. FIG. 3 shows a side view of the massage pole 100 anchored high on a wall 7. A user 8 has positioned the massage head 4 on the trapezius muscle, and is pulling downwards on the pole 1 to drive the massage head 4 into the trapezius muscle. The pole 1 is anchored to the wall 7 at its distal end by an anchoring means 2 comprising a rubber gasket or stopper. The rubber stopper keeps the distal end of the pole from sliding out of position.

FIG. 3 illustrates how the user's 8 arms are in a natural, forward-facing position so that the shoulders are relaxed. By grasping the pole 1 firmly and leaning forward slightly, the user 8 may use his or her own body weight to pull downwards on the pole 1, creating a powerful downwards force in the massage head 4. The slight flexion of the pole combined with the lever effect caused by its being anchored at the distal end amplifies the force of the massage. The user 8 may rotate his or her body slightly under the massage head 4 to fine-tune the angle and intensity of the massage pressure being applied to the target muscle, alternatively or additionally, the user 8 may vary the force applied to the pole 1.

In order to perform the massage exercise depicted in FIG. 3, the user 8 begins by holding the pole 1 upright and then he or she places the anchoring means 2 against the wall 7 at shoulder level. While gently pushing the massage pole 100 against the wall 7 to maintain friction at the anchor point, the user 8 leans forward at the waist and lowers the proximal end 3 of the pole 1 until the massage head 4 rests upon the trapezius muscle. The user 8 may then clasp one or both hands comfortably out in front of himself or herself and around the pole 1 at a position between one and three feet away from the massage head 4. The user 8 may then pull downwards on the pole 1 by leaning forward slightly and allowing gravity to pull the arms downwards against the pole 1, while also pulling downwards using a slight amount of muscle power. Instead of standing, the user may also perform this activity from a sitting, squatting, or other different position.

This activity takes advantage of the lever function of the anchored massage pole and it drives the massage head downwards into the trapezius muscle. The length and slight flexibility of the pole allow the user to make fine adjustments to the force and direction of pressure applied through the massage head because minute movements in the arms and hands, combined with slight adjustments in posture, are transformed by the lever of the pole into more powerful and more elaborate strokes. The texture of the tissues underneath the massage head creates vibrations that travel up through the massage head and into the proximal end of the pole where they can be detected by the fingers of the user holding the pole. This permits palpitation and helps the user to identify the size and location of adhesions (“knots”) or other relevant features of texture.

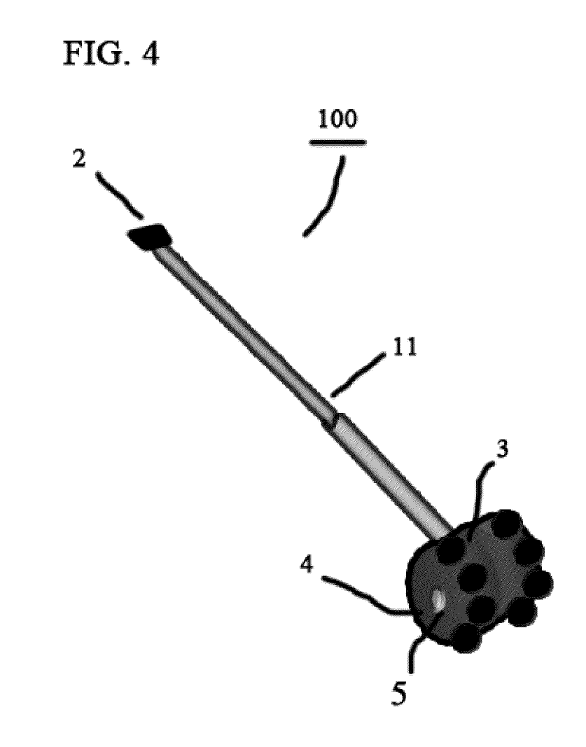

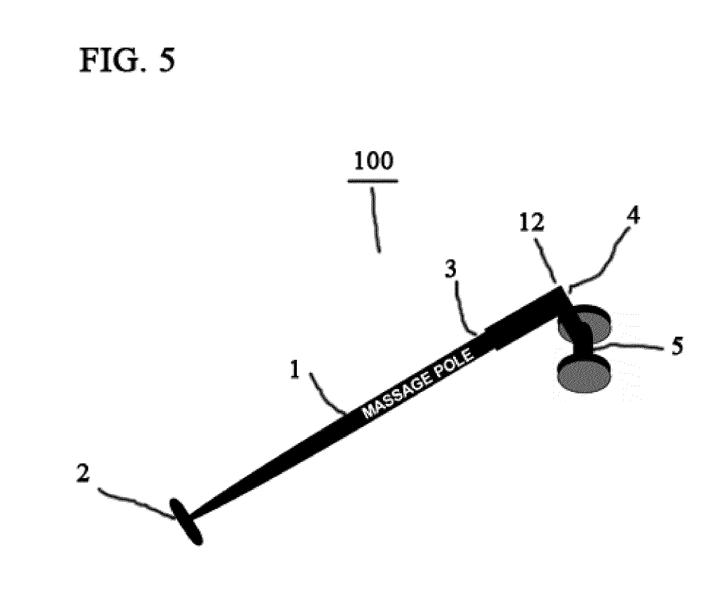

The massage head may have prongs, fingerlike protrusions, disc-shaped termini, bulbous protrusions, studs, or other surface structures which direct the force of the massage into the targeted muscle. In this fashion, the user may remain in a comfortable relaxed state while exerting minimal effort to self-apply massage therapy to the back, in this example, but also to any other area of the body. FIG. 4 illustrates the massage pole 100 of the present invention having a massage head 4 comprising two rotating wheels with rubber studs mounted on a carriage that is rigidly attached to the proximal end 3 of the pole 1. The wheels may be freely rotating, or they may be fitted with a means for adjusting the resistance to rotation in order to regulate the amount of force required to roll the wheels. The pole may be a two-part extendible pole 1 or other type of extendable handle. FIG. 5 illustrated a modification of the rigidly attached massage head 4 connected to the pole 1 in which a base portion 12 of the massage head 4 has an L-shape.

A further innovation offered by the present invention is the versatility of its anchoring means. FIG. 5 illustrates an embodiment of the massage pole 100 of the present invention in which the anchoring means 2 comprises the sliding collar 9 of a smith machine 10.

The collar 9 may be moved up and down by any increment along the pole around which it sits on the smith machine 10.

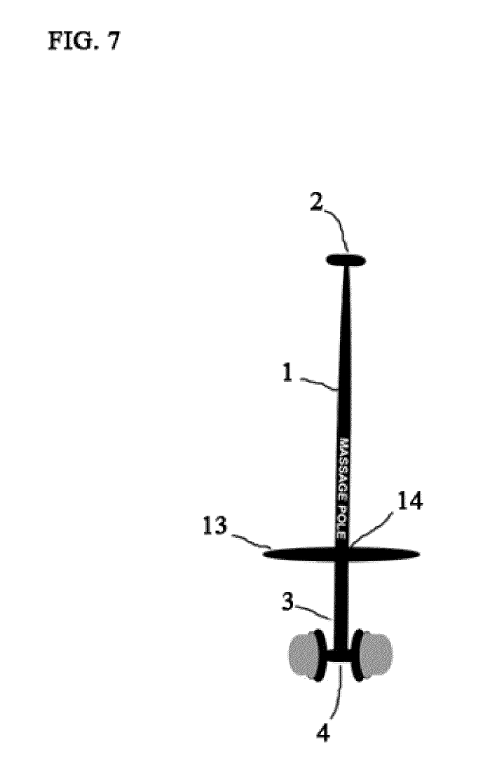

Still a further innovation is the use of the pole as a lever. The amount of force and control that a user may exert against the pole can be augmented by the inclusion of a cross bar or handle grip as shown in FIG. 7. In this embodiment, a cross bar 13 is attached to the pole 1 at an attachment point 14. The cross bar may be a rigid pole or it may simply be an attachment for leather straps, rubber bands, or other means for handling the device. When the cross bar 13 is a rigid pole, as in FIG. 7, a user may grip either side of the cross bar 13 like handlebars on a bicycle to pull, push, twist, or otherwise control the pole 1. This provides increased macro- and micro-control of massage head movements and pressure. The attachment point 14 may be stationary or adjustable, such that the position of the cross bar 13 may be moved along the long axis of the pole 1. When the cross bar 13 comprises leather straps, rubber bands, or other manual controlling means, they are attached at an attachment point 14 but do not necessarily extend linearly outwards in a transverse relationship to the pole 1. Instead, they may hang underneath, wrap around, or extend in any direction from the pole 1.

The present invention is intended for use in any type of massage therapy involving physical manipulation of body tissues. The following description of massage therapy techniques which can be self-applied using the present invention demonstrates the unique versatility of the invention and its particular utility in these examples.

### Active Release Therapy (ART) Massage

The present invention is intended to be used in place of a masseuse's hands in active release therapy (ART) massage. ART is most commonly used to treat conditions related to adhesions or scar tissue in overused muscles. As adhesions and scars build up, muscles become shorter and weaker, the motion of muscles and joints are altered, and nerves can be compressed. As a result, tissues suffer from decreased blood supply, pain, and poor mobility. The goal of ART is to restore the smooth movement of tissues and to release any entrapped nerves or blood vessels.

In the application of ART, specific motions of the body are used to make layers of soft tissue slide over one another while contacting the injured area with a hand, finger or thumb. This physical contact may be applied lightly or very forcefully to break up an adhesion, force a layer of muscle to slide over another muscle or separate a nerve from connective tissue or a layer of muscle. In addition to muscle stiffness, soreness, and immobility, ART treats other specific conditions including headaches, back pain, carpal tunnel syndrome other peripheral nerve entrapments, shin splints, sciatica, TMJ, plantar fasciitis, tendonitis and other soft tissue inflammatory disorders of the joints.

The device of the present invention can be used by an individual to self-perform ART, because the user can assume any position and then apply the massage head of the device to the affected area, using a hand, arm or other leverage means to apply the desired level of force against the pole of the device. For example, the device can be anchored to a position on a wall while the user stands facing the massage head. The massage head can be placed against the pectoral muscle, and the user can lean into the massage head with varying intensity. The massage head may provide a slightly compressable but rigid medium to transfer force from the anchor point to the muscle. By leaning at an acute angle towards the anchor point, using gravity to magnify the force of impression by the massage head into the muscle tissue, a tremendous amount of force can be applied to the deep tissues of the target area of the body. By gently twisting his or her torso or alternatively/simultaneously by manipulating the pole with his or her hands, the user can rub the massage head back and forth over the pectoris to push layers of muscle into, over, or away from one another to replicate the techniques of ART.

### Acupressure

The device of the present invention can be used to self-perform acupressure massage therapy. Acupressure is a form of touch therapy that borrows from principles of acupuncture and Chinese medicine. In acupressure, the same points on the body are used as in acupuncture, but they are stimulated with finger pressure instead of with the insertion of needles. The acupressurist will gently press with their hands, fingers and elbows on various acupoints across the body to unblock energy and to encourage blood and lymph flow. The free circulation of blood and lymph fluid will encourage energy (chi) and promote healing. Acupressure is used to relieve a variety of symptoms and pain. Acupressure has been used as a way to relax the mind and body, to increase blood circulation, soothe stress, muscle pain, headache, improve overall energy levels, and to help the body dispose of dangerous toxins.

The present invention is intended to replace finger, palm, elbow, and other types of manual acupressure contact methods by virtue of the rounded or pronged ends of the contact surface of the massage head. The exceptional mobility, directional and force control provided by the present invention permits a user to self administer any type of acupressure touching to any part of the body. For example, a user may anchor the present invention to a point elevated approximately 2 feet from the floor. The user may then lie down on a mat facing the device and let the massage head rest on any part of the user's back. The user may keep his or her elbows comfortably on the floor while extending the forearms upwards to grasp the pole 1. By pulling downwards on the pole, the pressure of the massage head against the back can be amplified and regulated.

### Deep Connective Tissue Massage

Deep connective tissue massage (“Deep tissue massage”) is a form of intense massage that aims to release myofascial (connective tissue) restrictions in the body, and to break up any restrictive scar tissue. It has also been known to help relieve chronic tension, to increase the body's range of motion, to improve posture and to enhance the natural harmony of the entire body and mind. This type of massage focuses on the muscles located below the surface of the top muscles. Deep tissue massage is applied to both the superficial and deep layers of muscles, fascia, and other structures. The sessions are often quite intense as a result of the deliberate, focused work. Deep tissue massage is often recommended for individuals who experience consistent pain, are involved in heavy physical activity (such as athletes), and patients who have sustained physical injury. Deep connective tissue massage borrows many of its techniques from traditional Swedish massage. During a session, the massage therapist will focus on releasing tension from the deeper tissue structures of the muscle and fascia (or connective tissues) with deep, intense strokes. Emphasis is placed on identifying adhesions (chronic knots) and applying direct pressure upon them from various angles to physically break them apart.

Prior to the introduction of the present invention, no affordable, convenient device existed which enabled deep tissue massage because prior art devices failed to deliver the requisite leverage, directional control, reach, and versatility. By placing the massage head of the present invention over a target muscle or tissue and pulling downwards on the pole, an intense amount of force can be precisely directed to the target area. By pivoting the angle of the pole slightly, minute adjustments to the direction of force can be achieved. Conversely, by pivoting the angle of the pole to a large degree, very large changes in both directionality and force against a target tissue can be achieved. The user can push the pole of the present invention up and down, side to side, or in a variety of other ways to cause the massage head to slide over the tissues of any muscle. Long strokes in this manner replicate the performance of deep tissue massage.

Deep tissue massage is a category of massage therapy distinct from “deep muscle” or “deep pressure” therapy. Deep tissue massage is generally used to treat particular muscular-skeletal disorders and complaints and employs a dedicated set of techniques and strokes to achieve a measure of relief. It should not be confused with “deep pressure” massage, which is one that is performed with sustained strong, occasionally intense pressure throughout an entire full-body session, and that is not performed to address a specific complaint. Deep tissue massage is so rigorous that it is generally considered stressful for a person to receive it over his or her entire body in one session.

### Deep Muscle Therapy

Deep muscle therapy is performed to remove adhesions (chronic knots) that exist within the deep muscle tissues, causing imbalances in the body's natural mechanics. Injured fibrous tissues forming adhesions can cause chronic joint and muscle pain, poor posture and coordination, and a plethora of other health ailments. Deep muscle therapy is often uncomfortable, compared to a traditional relaxation style of massage (such as Swedish massage), and the therapist will only massage as deeply as the client is comfortable with. This means that the client must keep their massage therapist informed of their pain tolerance at all times during the session.

The present invention gives the user complete control over the depth of the massage, avoiding the discomfort that can occur when this type of therapy is performed by another person. The present invention enables an individual to achieve the benefits of deep muscle massage without the inconvenience, discomfort, and embarrassment of undergoing this rigorous therapy under the control of another person. As with deep tissue therapy, the device of the present invention enables, for the first time, the self-application of this therapy with the same force and effectiveness as if performed by another, while prior art devices fail to deliver the requisite force and control. One method by which this can be achieved is by using a massage head with rolling wheels or other rotating elements that rolls over the tissues when the massage pole is used on the body.

### Myofascial Release

The myofascial release approach is a form of soft tissue therapy used to treat somatic dysfunction and resulting pain and restriction of motion. “Myo” is an etymological root for “muscle” while “fascia” refers to connective tissue surrounding muscle. The targets of myofascial release are muscle and fascia, which are soft tissues that can become hardened, inflamed, or constricted due to disease, overuse, trauma, or inactivity, often resulting in pain, muscle tension, and corresponding diminished blood flow. Other tissue may be affected as well, including other connective tissue. Myofascial release therapy is applied hands-on, in kneading-style strokes that are meant to stretch, loosen, soften and lengthen muscle and fascia. The strokes are applied with gentle pressure, and held for approximately 2-mintues in order for the stretch to have its full effect on the muscle. Typically the same stretch is performed more than once by the therapist until the muscle is totally relaxed and a release is felt. The therapist will always apply massage in the direction of the muscle fibers to encourage the full range of motion of the muscle.

The direct myofascial release (or deep tissue work) method works through engaging the myofascial tissue restrictive barrier, the tissue is loaded with a constant force until tissue release occurs. Practitioners use knuckles, elbows, or other tools to slowly stretch the restricted fascia by applying a few kilograms-force or tens of newtons. Direct myofascial release seeks for changes in the myofascial structures by stretching, elongation of fascia, or mobilising adhesive tissues. The practitioner moves slowly through the layers of the fascia until the deep tissues are reached.

The indirect method involves a gentle stretch, with only a few grams of pressure, which allows the fascia to ‘unwind’ itself. The dysfunctional tissues are guided along the path of least resistance until free movement is achieved. The gentle traction applied to the restricted fascia will result in heat and increased blood flow in the area. This allows the body's inherent ability for self correction to return, thus eliminating pain and restoring the optimum performance of the body.

Myofascial release produces total release of body tension and is useful for soothing a plethora of pain-associated conditions including migraine headaches, menstrual cramps, menopause-related pain, carpal tunnel syndrome, arthritis, Fibromyalgia, whiplash and muscle spasms.

The present invention provides simulated kneading when the device is pivoted back and forth by raising and lowering the pole while the massage head is sliding against part of the body. A user may also slide the massage head down the length of a muscle and then lift the pole and return to the starting point of the stroke and thereby maintain unidirectional kneading motions. Bi-, uni-, or multi-directional kneading may also be achieved when the user moves back and forth under the device when the massage head is placed against the target area of the body.

### Neuromuscular Therapy

Neuromuscular Therapy massage is applied in various pressures by the therapist using a combination of effleurage or gliding, petrissage or grasping, friction, muscle energy, and strain/counter-strain massage techniques. The therapist will locate the muscle spasm and then concentrate the hands-on treatment to this area by applying continuous pressure for about 30-seconds with their fingers, knuckles and elbows. The same pressure must be maintained by the massage therapist for the entire 30-seconds in order to encourage proper blood flow in the area. Typically, before a neuromuscular therapy massage begins, the practitioner will tell the client to alert them immediately if the pressure is painful. The therapist will often check in with their client during the massage to ask if the stroke pressure is too light, too hard, or comfortable. The therapist will then adjust their pressure according to their clients verbal cues.

The device of the present invention eliminates the complication of having to relay messages to a therapist. A user may position himself or herself in a position where a certain muscle is in either a fully stretched or fully contracted position. The device may be pulled or pushed so that the massage head alternatively impacts against or glides over the target tissue.

### Swedish Massage

The Swedish Massage technique is characterized by firm, yet calming pressure that improves blood circulation, eases muscle tension, and improves flexibility. It employs a series of long, gliding strokes, kneading of the muscles, and vibrational taps. A Swedish masseuse will also create friction and perform “hacking” or tapping across a clients back and shoulders to promote the release of tension. Five basic strokes: gliding, kneading, vibrations, friction and hacking are all applied in the direction of the heart in order to encourage blood circulation and the disposal of bodily waste. A Swedish massage therapist will always use massage oils to achieve the smooth, long and deep strokes over their clients body. Therapists apply the oil to reduce friction, and essential oils are sometimes used in order to tap into a clients olphactory senses (sense of smell). During a Swedish massage a sheet is worn, otherwise the client is nude. However, body parts are only uncovered when they are being massaged.

The device of the present invention contemplates embodiments that are manufactured from materials compatible with massage oils. The massage can be self-performed privately to eliminate the embarrassment of being unclothed in the presence of a masseuse. Using the exercises described above, the user may replicate each of the strokes involved in a Swedish massage. However, in order to generate gentle pressure rather than strong pressure, the user would pull gently on the pole, or would lean very slightly into the massage head, when performing the massage.

### Sports Massage, Administered Both Before and After Exercise

Sports massage is a direct descendant of Swedish massage because both techniques help heal injuries like muscle sprain and spasms. Many of the techniques of sports massage such as strokes applied in the direction of the heart are borrowed from Swedish massage. This technique is just as important for athletes as it is for relaxation—the body is encouraged to disperse lactic acids in the muscles in order to make room for a fresh supply of blood and oxygen. It specifically alleviates muscle tension and inflammation post-event, and provides a warm-up to loosen muscles for amateur and professional athletes pre-event.

Sports massage will help release any built up tension and lactic acid in the overworked muscles so that blood and oxygen can return to the muscle and effectively promote muscle repair. Sports massage, if received as part of a sports program, can help an athlete prevent injury. A pre-event massage is brief and invigorating, usually lasting 15-20 minutes. It is given within an hour before the sporting event, through the clothes to warm up the muscles. Post-Event Massage should be calming and relaxing. Its goal is to ease muscle pain (by decreasing tension), muscle soreness (by dispersing lactic acid), and to reduce inflammation. A post-event massage should last no more than 15- to 20-minutes, and it should be administered through the athletes clothes. Post-event massages encourage the return of blood and oxygen to tense areas, and they flush out metabolic waste products that have built up during strenuous muscle use.

The device of the present invention is useful for sports massage. A user can slide the massage head against the body while simultaneously leaning into and out of acute angles to produce long strokes against any muscle, alternating between deep and superficially pressure simply by altering body posture. The massage pole of the present invention is easily portable and very rugged, so it can be used outdoors and stored with athletic equipment. In some embodiments, the massage pole is water-resistant and corrosion-resistant for use outdoors.

### Thai Massage

During a traditional Thai massage the masseuse will use their hands, elbows, knees and feet to apply various pressures to the sen (or energy lines) along the body. The sen are taken very seriously in Thailand because they are considered the keys to a happy and healthy life. Thai Massage is practiced on a firm mat on the floor. The masseuse will only use their own body weight to apply various pressures to the sen.

The device of the present invention allows a person to lie on their back or stomach. When the anchor point of the device is mounted to a location above the body, the user may easily reach upwards and pull the pole downwards with natural, comfortable arm movements to stimulate the pressure of being stepped on by a Thai masseuse. Even while lying on one's stomach, it is easy to reach forward and hang one's hands on the pole to pull it downwards onto the muscles of the back. The extended length of the pole compared to the short handles which predominate in the prior art mean that the massage head may be placed against the back of the legs while the user's arms are comfortably grasping the pole at a position near the back of the neck. The lever action of the pole, being anchored at its distal end, enables very slight pressure and adjustments to generate large forces and changes in the massage action farther down at the proximal end of the device. It allows the user to directly control the amount of pressure to achieve precisely the right amount of force appropriate for their body type and tolerance.

### Palpitation

Palpitation consists of the therapist examining the fascial tissues, feeling for imbalances in the tissue texture and quality. The rubberized massage head and other types of massage heads compatible with the present invention, being directly attached to the pole arm without any intervening elastic elements or joints, create a continuous conduit for vibrations and sensory information to travel from the massage head to the pole when the massage head is passed over parts of the body. The construction of the pole as a single piece of semi-flexible material enhances this signal transduction effect. This in turn, enhances the user's ability to palpitate areas on his or her own body and detect adhesions, roughness, or other abnormalities. Although not as sensitive as the hands and fingers, the present invention is far more sensitive than devices with hard wooden or inflexible plastic or metal contact apparatus. This allows a patient to self-assess where therapy needs to be applied. This self-assessment serves as a viable substitute for discrimination, which is the procedure in which a therapist determines the nature and location of tissue abnormalities in a subject during palpitation.

### Transcutaneous Electrical Nerve Stimulation (TENS)

Transcutaneous electrical nerve stimulation is a technique that applies electric current produced by a device to stimulate the nerves for therapeutic purposes, several of which are commercially available. The massage pole of the present invention may include a massage head on which is mounted a TENS device, or the electrodes of a TENS device. When the massage head is positioned on or above a target area of the body, the electrical current will be applied through the electrodes mounted on the massage head to the target area of the body. The cross bar 13, as depicted in FIG. 7, may house controls for the TENS device so that the intensity, duration, and other parameters of the TENS therapy may be controlled during a massage. In this configuration, the massage pole of the present invention can deliver transcutaneous electrical nerve stimulation to any tissues of the body.

In summary, the present invention, by permitting the self-application of the gamut of massage techniques, enables an individual to achieve excellent results for a cost far lower than if received from a masseuse or therapist. The device itself is constructed from materials that permit, in at least several embodiments, a consumer price of $100 or less. No other specialized tables or other equipment are necessary to achieve the full functional benefits of the device. It is lightweight and conveniently portable, it is durable and weatherproof, and it can be used safely and effectively in any location, indoors or outdoors. Any small stable surface or groove, either vertically or horizontally oriented, can be used to support the anchor means of the device. It can even be used in grass, soil, firm sand, against a tree, or a range of outdoor surfaces.

It should be emphasized that the above described embodiments of the present invention exemplify some, but not all, possible implementations of the present invention and have been set forth in order to provide a clear understanding of its qualities. Variations and modifications may be made to the above-described embodiments of the present invention without departing from the spirit and principles of the invention. All such modifications and variations are intended to be included herein.

What is claimed is:

1. A portable massage device comprising:
a pole having a length of between three and twelve feet fashioned from a slightly flexible material having substantial tensile strength,
said pole having a distal end whereupon is attached an anchoring means for stably positioning said distal end of said pole during use, and said pole having a proximal end whereupon is attached a massage head element,
wherein said massage device comprises a class three lever such that the anchoring means comprises a fulcrum and the pole comprises a beam and the massage head applies a load to the body of a person.

2. The massage device of claim 1, further comprising a handle element attached to the pole at a position intermediate between the distal end and the proximal end.

3. The massage device of claim 2, wherein the position of the handle element is adjustable.

4. The massage device of claim 2, wherein the handle element comprises a handlebars, a crossbar, a rope, or any other handle apparatus known in the field of physical fitness equipment.

5. The massage device of claim 4, wherein the handle element comprises one or a plurality of elastic bands.

6. The massage device of claim 1, wherein the massage head element comprises one or a plurality of rollers.

7. The massage device of claim 1, wherein the massage head element comprises fingerlike protuberances.

8. The massage device of claim 1, wherein the massage head element comprises a means for delivering transcutaneous electronic nerve stimulation.

9. The massage device of claim 1, wherein the massage head element comprises the carriage and wheels of a landsurfing apparatus.

10. The massage device of claim 1, wherein the massage head element is removably attached in order to permit the attachment of a variety of interchangeable massage head elements.

11. The massage device of claim 1, wherein the device is waterproof and corrosion-resistant.

12. The massage device of claim 1, wherein the anchoring means connects to a vertically adjustable exercise apparatus such as a Smith Machine.

13. The massage device of claim 1, wherein the anchoring means connects to a mounting means, said mounting means acting to secure the distal end of the pole in a certain functional position.

14. The massage device of claim 13, wherein the mounting means is a bracket mounted to an external surface, wherein said external surface is a wall, floor, ceiling, or the like.

15. The massage device of claim 1, wherein the anchoring means comprises a knob fashioned from a material having a high coefficient of friction, wherein said material comprises synthetic rubber, plastic, wood or the like.

16. The massage device of claim 1, wherein the pole is fashioned from pressure treated lumber.

17. The massage device of claim 1, wherein the pole is fashioned from one or a plurality of plastic compounds.

18. The massage device of claim 1, wherein the pole comprises multiple sections and the length of the pole is adjustable.

19. A method for a person to perform self-massage using the portable massage device of claim 1, the method comprising the steps of:
stably positioning the anchoring means at a height ranging between several feet below floor level to several feet overhead,
positioning the massage head element against a location on the body of the person where massage and muscle manipulation are desired by the person,
and manipulating the pole by grasping the pole at a position intermediate between the distal and proximal end, such that the device acts as a class three lever and the massage head element applies a load which provides beneficial force to the location on the body.

20. The method of claim 19, further comprising the steps of:
continuously manipulating the pole during a bout of self-massage by applying varying degrees of pressure to the pole in one or a plurality of directions such that the massage head element dynamically manipulates the subcutaneous tissues at the location on the body.

21. The method of claim 19, further comprising the steps of:
achieving the manipulation of the pole by grasping a handle element attached to the pole.

22. The method of claim 19, further comprising the steps of:
engaging in a massage routine wherein the anchoring means is positioned at various heights and the massage head is applied to various locations on the body, and wherein the body is moved beneath the massage head to enhance the massaging effect of the massage head element.
